(19) United States
(12) Patent Application Publication
(10) Pub. No.: US 2011/0265537 A1
(43) Pub. Date: Nov. 3, 2011

(54) ROLL FOR A ROLLING-MILL

(75) Inventors: Paolo Marin, Vigevano (IT); Marcello Pacher, Bareggio (IT); Giuseppe Vigo, Milano (IT); Alberto Bregante, Milano (IT)

(73) Assignee: SMS INNSE SPA

(21) Appl. No.: 13/144,278

(22) PCT Filed: Jan. 15, 2010
(86) PCT No.: PCT/IB10/50184

§ 371 Date: Jul. 12, 2011

(30) Foreign Application Priority Data
Jan. 19, 2009 (IT) MI2009A000044

(51) Int. Cl. B21B 28/02; B21B 13/00; B23B 1/00; B21B 27/02

(52) U.S. Cl. 72/234; 72/237; 82/1.11; 72/252.5; 492/1

(57) ABSTRACT

The present invention relates to a roll (26) for rolling a long semifinished article (18). The roll is rotatable about an axis of rotation (r) and comprises: a groove (44) able to reproduce a nominal arc (h) of the outer profile of the semifinished article; and a groove plane (π) which intersects, perpendicularly with respect to the axis of rotation, the roll along its smaller section. The roll is asymmetrical with respect to the groove plane (π). The invention also relates to a rolling station (22) and a continuous rolling mill (20) which comprise a plurality of such rolls. Finally, the invention relates to a method for reconditioning these rolls.

The present invention relates to a roll for a continuous rolling mill, in particular for a continuous rolling mill suitable for the production of long semifinished articles, for example seamless tubes, bars, rods, round bars and the like. The invention also relates to a roiling station and a rolling mill comprising said roll. Finally, the invention relates to a method for reconditioning the roll when it is worn. In the description below specific reference will be made, by way of a non-limiting example, to the production of seamless tubes.

It is known to produce seamless metal tubes by means of successive plastic deformation of a billet or bat in the form of a blank. During a first step, the billet is pierced longitudinally so as to obtain a pierced semifinished blank with a thick wall and length 1.5 to 4 times greater than that of the initial billet. Then this semifinished blank is passed through special rolling mills so as to thin gradually the wall and increase the length of the finished product. These rolling mills, known as continuous rolling mills, comprise in a manner known per se a plurality of stations. Each station comprises a stand on which rolls with profiled grooves are mounted. Usually the grooved rolls are three in number and each supported via a pair of arms by a special roll-support lever mounted on the stand. The three pairs of arms arc coplanar with each other, have a radial direction and are arranged at intervals of 120° from each other around the rolling axis. The set of connected profiles of the grooves of the three rolls defines the external circumference of the tube leaving the rolling station. In each station, the roll-support levers are mounted on a cartridge so as to be able to pivot about an axis parallel to the rolling axis. A hydraulic actuator acts on each of the rolls and pushes the roll in the radial direction relative to the rolling axis. The actuators thus produce the force requited to deform plastically the tube. Moreover, the rolls are rotated by special motors so as to provide, by means of friction, the feeding movement to the tube being processed.

The following stations, together with an internal mandrel where necessary, gradually convert the semifinished blank into a tube with the desired configuration in terms of outer diameter, inner diameter, wall thickness and length.

The rolling rolls are subject to wear and, following given working cycles, must be reconditioned by means of a turning operation. In this way it is possible to eliminate the deformation and wear marks and restore the groove profile and the correct symmetry of the roll. It is in fact required to ensure an optimum profile of the groove of each roll so that the individual station may provide the tube being processed with an optimum profile.

Turning may be performed, in a manner known per se, by disassembly of each roll from the respective position and transportation to a suitable conventional turning station. Alternatively, in a manner equally well known per se, it is possible to keep the three rolls of each station mounted on the respective stand and perform the turning operation using a special tool arranged in the centre of the station in place of the tube.

Each turning operation necessarily reduces the diameter of the individual roll. For this reason, it is known to provide on each stand means for keeping the rolls parallel to themselves before and after each turning operation.

It is clear that, following a reduction in diameter, the roll could be brought into contact with the tube by means of simple pivoting of the lever about its axis. This configuration of the roll, however, would be asymmetrical with respect to the radial direction and the contact would not be optimal. In other words, after turning, the set of profiles of the grooves of the three rolls would no longer define a circumference; instead it would define a three-lobed figure composed of circle arcs which are not connected together.

In order to overcome this problem, two different solutions are known.

The first solution consists in compensating for the reduction in diameter of the roll by means of an identical lengthening of the respective arms. In this way the movement of the roll, between the initial position and the position following turning, is a purely translatory movement in the radial direction passing along the groove bottom. The roll therefore remains parallel to itself.

The second solution consists in compensating for the reduction in diameter of the roll by means of an identical displacement of the pin about which the roll-support lever rotates. In this way the movement of the entire lever, between the initial position and the position following turning, is a purely translatory movement in the radial direction passing along the groove bottom. The roll therefore, in this case also, remains parallel to itself.

The two known solutions described above, although widely used, are not defect-free. As regards the first solution, owing to the masses and dimensions involved, the arm lengthening operation is long and laborious. Moreover, this lengthening is usually achieved by means of arranging special calibrated spacers along the arm. With this type of solution, therefore, it is required to provide and manage a large stock of spacers. In fact, each rolling station requires three complete series of spacers; each series must contain a number of spacers equal to the number of turning operations which can be performed on the rolls from the time when they are new to when they are completely worn.

As regards the second solution, again owing to the masses and dimensions involved, displacement of the pins is a long and laborious operation. This displacement is usually obtained by means of a series of cams which must be rotated at the same time so as to obtain a purely translatory movement for the pin of the lever.

The object of the present invention is therefore to overcome at least partly the drawbacks mentioned above with reference to the prior art.

In particular, a task of the present invention is to provide a roll for a continuous rolling mill which is able to compensate for the reduction in the diameter following reconditioning by means of turning in a simple and rapid manner.

The abovementioned object and tasks are achieved by a roll in accordance with that claimed in Claim 1.

The characteristic features and further advantages of the invention will emerge from the description, provided hereinbelow, of a number of examples of embodiment, provided purely by way of a non-limiting example, with reference to the accompanying drawings in which:

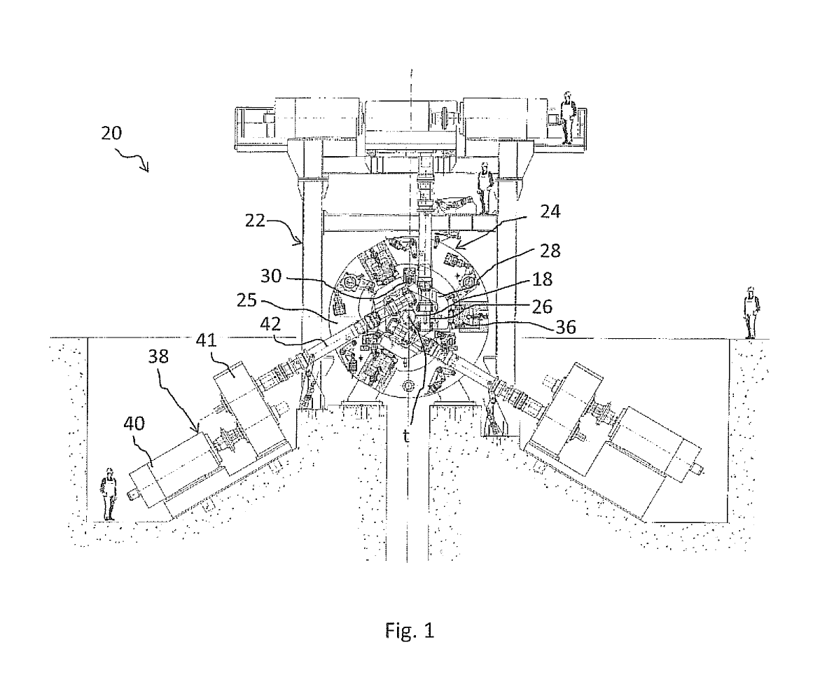

FIG. 1 shows a front view of a continuous rolling mill of the known type;

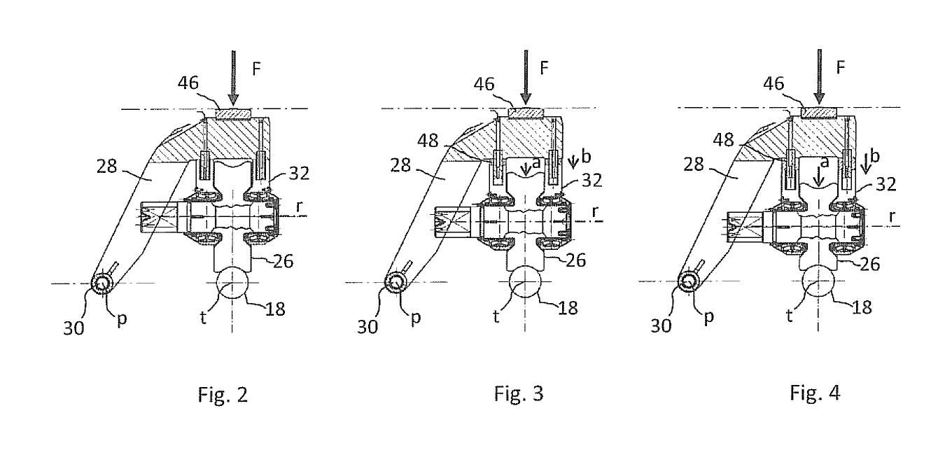

FIGS. 2 to 4 show a first roll/lever unit of the known type during three successive stages of its working life;

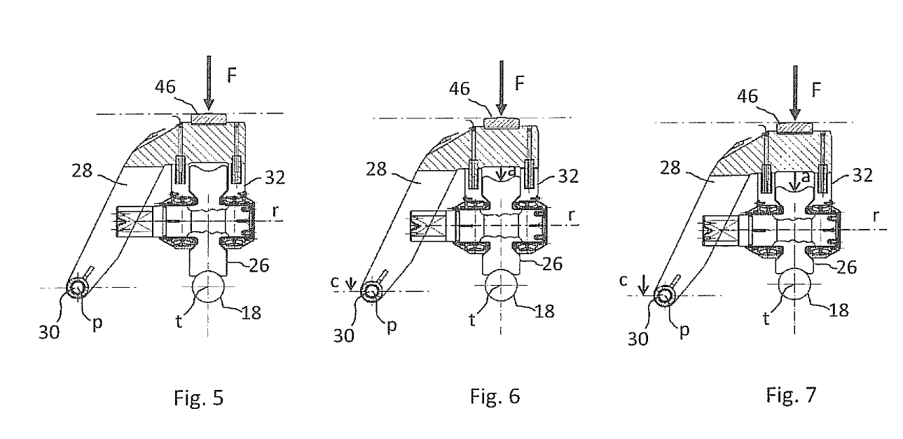

FIGS. 5 to 7 show a second roll/lever unit of the known type during three successive stages of its working life;

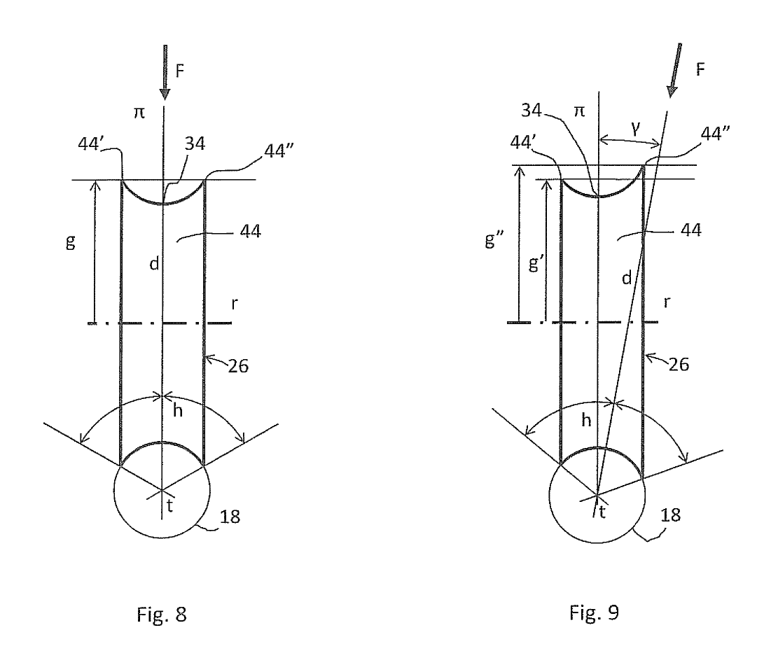

FIG. 8 shows schematically the geometrical form of a rolling roll of the known type;

FIG. 9 shows schematically the geometrical form of a rolling roll according to the invention;

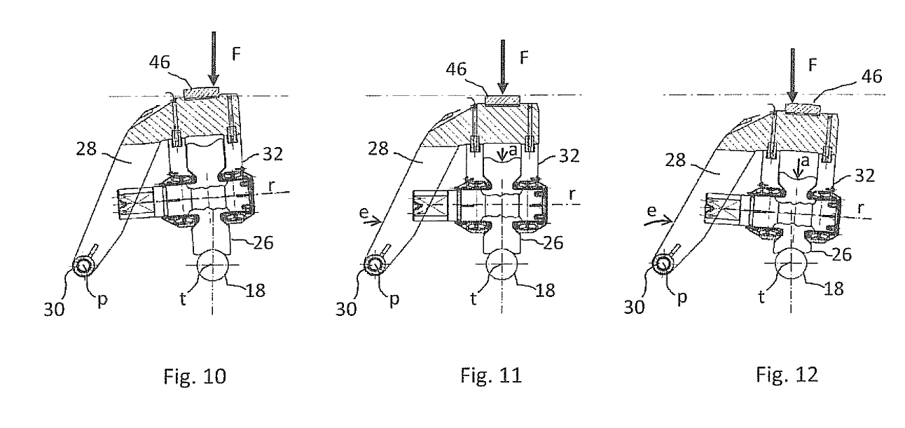

FIGS. 10 to 12 show a roll/lever unit according to the invention during three successive stages of its working life;

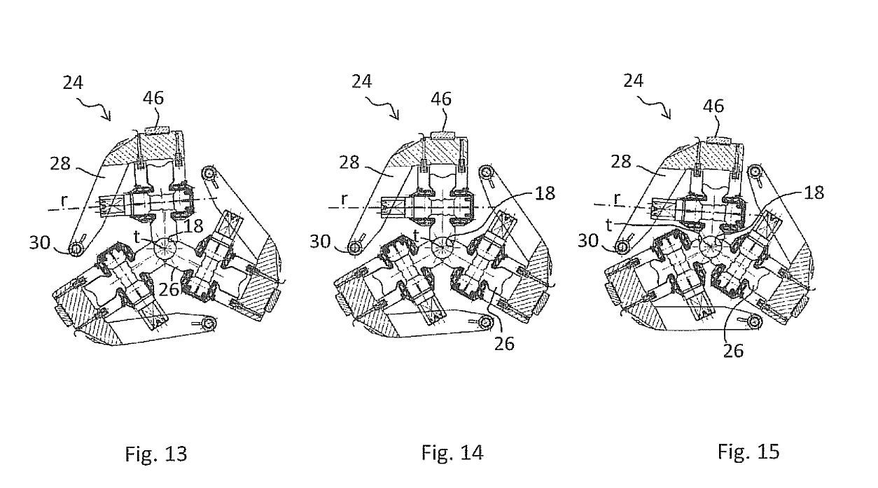

FIGS. 13 to 15 show a rolling stand according to the invention during three successive stages of its working life;

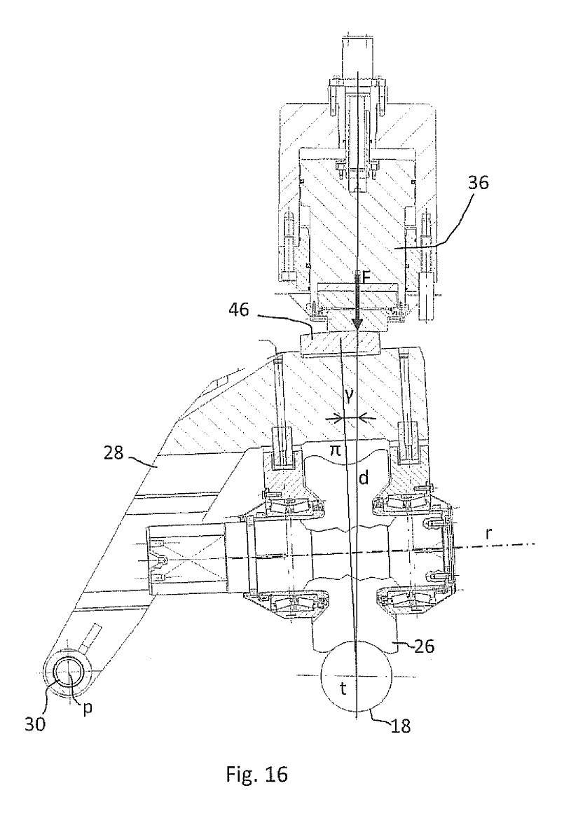

FIG. 16 shows a roll/lever/actuator unit according to the invention during an initial stage of its working life;

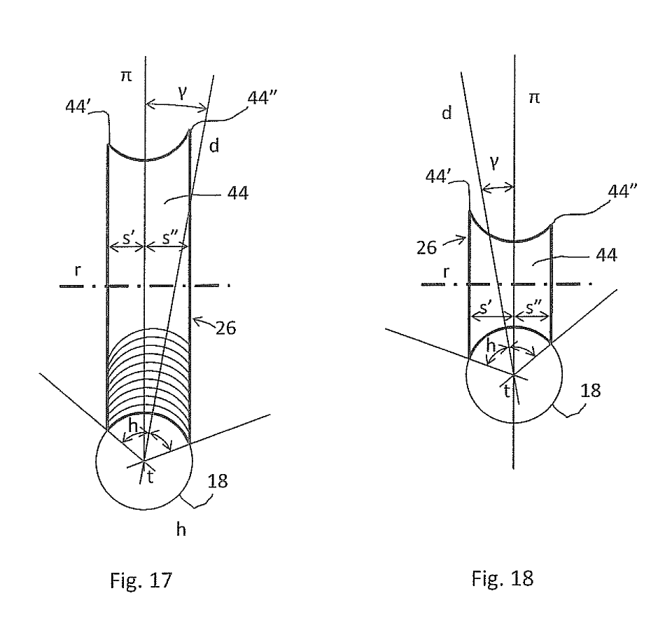

FIG. 17 shows schematically the geometrical form of a new rolling roll according to the invention;

FIG. 18 shows schematically the geometrical form of a worn rolling roll according to the invention.

With particular reference to the accompanying FIG. 1, 20 denotes a continuous rolling mill in its entirety. With reference to the rolling mill 20, it is possible to define univocally a rolling axis t, which is the longitudinal axis of a tube 18 being processed. A continuous rolling mill 20 comprises, in a manner known per se, a plurality of stations 22 which are arranged along the rolling axis t.

Each station 22 comprises a rolling stand 24 comprising a plurality of rolling rolls 26 mounted on a cartridge 25. There are normally three rolling rolls 26 for each station 22. With this solution it is possible to obtain a suitable compromise between two opposing requirements. On the one hand, in fact, there exists the need to reduce the structural complexity of the individual station. On the other hand, there exists the need to divide up the outer profile of the tube 18 over as many rolls 26 as possible. It is not excluded however that, in order to satisfy specific requirements, the number of rolls 26 for each station 22 can be changed.

Each roll 26 is mounted on the cartridge 25 by means of a roll-support lever 28 (or simply lever 28). The lever 28 is mounted on the cartridge 25 so as to be able to pivot about a pin 30. The pin 30 has an axis p parallel to the rolling axis t. The lever 28 supports the roll 26 by means of two arms 32.

Each roll 26 comprises, moreover, an actuator 36 (visible in FIGS. 1 and 16) suitable for applying to the roll 26 a force in a radial direction with respect to the axis t. The force applied by the actuator 36, indicated by the bold arrow F in the figures, is that which produces the plastic deformation of the tube 18 being processed. In particular, the composition of the three forces F produced by the three actuators 36 of a station 22 results in a radial reduction in the thickness of the tube 18 and an axial lengthening of the tube itself. Advantageously, the actuator 36 comprises a hydraulic jack which acts on a thrusting surface 46 integral with the lever 28.

The station 22 also comprises motor means 38 suitable for causing the rotation of each roll 26. The rotation of the roll 26 performed by the motor means 38 is that which provides the feeding movement, displacing the tube 18 by means of friction along the axis t. Advantageously, the motor means 38 comprise an electric motor 40, a reduction unit 41 and a drive shaft 42.

Each roll 26 defines an axis of rotation r. The roll 26 is formed symmetrically with respect to the axis r and has, formed on its periphery, a groove 44 able to reproduce an arc h of the outer profile of the tube 18. In particular, in the case where each rolling station 22 comprises three rolls 26, each of them must act on a nominal arc h of 120°. The term groove bottom 34 is understood below as referring to the lowest point of the groove 44. For each roll 26 it is also possible to define a groove plane π which intersects, perpendicularly with respect to the axis r, the roll 26 along its smaller section.

During the course of their working life, the rolls must be periodically reconditioned in order to be able to ensure that the groove 44 has an optimum profile. Reconditioning is performed by means of a turning operation carried out on the roll 26, with the consequent gradual reduction of the diameter thereof.

The description provided above in general terms may be applied both to a rolling mill of the known type and to a rolling mill according to the invention. Below, instead, two different solutions with respect to the prior art are described in connection with the problems posed by the reduction in diameter following reconditioning of the rolls 26 by means of turning.

FIGS. 2 to 4 illustrate a first known solution. FIG. 2 shows a roll 26 at the start of its working life: it is symmetrical with respect to the axis of rotation r and with respect to the groove plane π. As can be seen in FIG. 2, the roll 26 and the lever 28 are configured so as to ensure absolute symmetry, disregarding the machining and assembly tolerances. In particular, the groove plane π comprises the radial direction along which the force F is applied. Moreover, the groove plane π bisects the pertaining nominal arc h, i.e. that on which the roll 26 acts.

FIG. 3 shows the roll 26 of FIG. 2 halfway through its working life. The diameter of the roll 26 has been reduced by the successive reconditioning turning operations required during the first half of the working life of the roll 26. In accordance with this known solution, the reduction in the diameter of the roll 26 is compensated for by means of the introduction of spacers 48 along the arms 32. The reduction in the diameter of the roll 26 is schematically indicated in FIG. 3 by the arrow a, while the lengthening of the arms 32 is schematically indicated by the arrow b. Even after the reconditioning operations performed, the roll 26 is still symmetrical with respect to the axis of rotation r and with respect to the groove plane π. Moreover, as can be seen in FIG. 3, the roll 26 and the lever 28 are configured so as to ensure again absolute symmetry, disregarding the machining and assembly tolerances. In particular, the groove plane π comprises the radial direction along which the force F is applied. Moreover, the groove plane π bisects the nominal arc h pertaining to the roll 26.

FIG. 4 shows the roll 26 of FIGS. 2 and 3 at the end of its working life. The diameter of the roll 26 has been further reduced by the successive reconditioning turning operations required during the working life of the roll 26. In accordance with this known solution, the further reduction in the diameter of the roll 26 is compensated for by means of the further introduction of spacers 48 along the arms 32. The reduction in the diameter of the roll 26 is schematically indicated in FIG. 4 by the arrow a, while the lengthening of the arms 32 is schematically indicated by the arrow b. Even after the reconditioning operations performed, the roll 26 is still symmetrical with respect to the axis of rotation r and with respect to the groove plane π. Moreover, as can be seen in FIG. 4, the roll 26 and the lever 28 are configured so as to ensure again absolute symmetry, disregarding the machining and assembly tolerances. In particular, the groove plane π comprises the radial direction along which the force F is applied. Moreover, the groove plane π bisects the nominal arc h pertaining to the roll 26.

FIGS. 5 to 7 illustrate a second known solution. FIG. 5 shows a roll 26 at the start of its working life: it is symmetrical with respect to the axis of rotation r and with respect to the groove plane π. As can be seen in FIG. 5, the roll 26 and the lever 28 are configured so as to ensure absolute symmetry, disregarding the machining and assembly tolerances. In particular, the groove plane π comprises the radial direction along which the force F is applied. Moreover, the groove plane π bisects the pertaining nominal arc h, i.e. that on which the roll 26 acts.

FIG. 6 shows the roll 26 of FIG. 5 halfway through its working life. The diameter of the roll 26 has been reduced by the successive reconditioning turning operations required during the first half of the working life of the roll 26. In accordance with this known solution, the reduction in the diameter of the roll 26 is compensated for by means of the displacement of the pin 30 parallel to the line traced by the groove plane π. The reduction in the diameter of the roll 26 is schematically indicated in FIG. 6 by the arrow a, while the displacement of the pin 30 is schematically indicated by the arrow c. Even after the reconditioning operations performed, the roll 26 is still symmetrical with respect to the axis of rotation r and with respect to the groove plane π. Moreover, as can be seen in FIG. 6, the roll 26 and the lever 28 are configured so as to ensure again absolute symmetry, disregarding the machining and assembly tolerances. In particular, the groove plane π comprises the radial direction along which the force F is applied. Moreover, the groove plane π bisects the nominal arc h pertaining to the roll 26.

FIG. 7 shows the roll 26 of FIGS. 5 and 6 at the end of its working life. The diameter of the roll 26 has been further reduced by the successive reconditioning turning operations required during the working life of the roll 26. In accordance with this known solution, the further reduction in the diameter of the roll 26 is compensated for by means of the further displacement of the pin 30. The reduction in the diameter of the roll 26 is schematically indicated in FIG. 7 by the arrow a, while the displacement of the pin 30 is schematically indicated by the arrow after the reconditioning operations performed, the roll 26 is still symmetrical with respect to the axis of rotation r and with respect to the groove plane π. Moreover, as can be seen in FIG. 7, the roll 26 and the lever 28 are configured so as to ensure again absolute symmetry, disregarding the machining and assembly tolerances. In particular, the groove plane π comprises the radial direction along which the force F is applied. Moreover, the groove plane π bisects the nominal arc h pertaining to the roll 26.

The main geometrical characteristics of the roll 26 of the known type are summarized in schematic form in FIG. 8. As can be noted and as already mentioned, the roll 26 is symmetrical both with respect to the axis r and with respect to the groove plane π. Moreover, the line d bisecting the pertaining nominal arc h, which also represents the direction of application of the force F, lies in the groove plane π. Finally, the two crests 44′ and 44″ of the groove 44 have the same radius g. The main geometrical characteristics of a roll 26 according to the invention are summarized in schematic form in FIG. 9. As can be noted, the roll 26 is symmetrical with respect to the axis r, but asymmetrical with respect to the groove plane π. Moreover, the line d bisecting the pertaining nominal arc h, which also represents the direction of application of the force F, forms an angle γ with the groove plane π. Finally, the two crests 44′ and 44″ of the groove 44 have different radii g′ and g″.

FIGS. 10 to 12 show the solution, according to the invention, for the problems posed by the reduction in diameter following reconditioning of the rolls 26 by means of turning. FIG. 10 shows a roll 26 at the start of its working life: it is symmetrical with respect to the axis of rotation r, but asymmetrical with respect to the groove plane π. As can be seen in FIG. 10, the radial direction along which the force F is applied forms an angle γ with the groove plane π. Moreover, the groove plane π divides the pertaining nominal arc h, i.e. that on which the roll 26 acts, into two unequal parts.

FIG. 11 shows the roll 26 of FIG. 5 halfway through its working life. The diameter of the roll 26 has been reduced by the successive reconditioning turning operations required during the first half of the working life of the roll 26. In accordance with the solution according to the invention, the reduction in the diameter of the roll 26 is compensated for by means of pivoting of the lever 28 about the pin 30. The reduction in the diameter of the roll 26 is schematically indicated in FIG. 11 by the arrow a, while the pivoting movement of the lever 28 is schematically indicated by the arrow e. Following the reconditioning operations performed, the roll 26 according to FIG. 11 is momentarily symmetrical with respect to the groove plane π and with respect to the axis of rotation r. In particular, the groove plane π comprises momentarily the radial direction along which the force F is applied. Moreover, the groove plane π bisects momentarily the nominal arc h pertaining to the roll 26.

FIG. 12 shows the roll 26 of FIGS. 10 and 11 at the end of its working life. The diameter of the roll 26 has been further reduced by the successive reconditioning turning operations required during the working life of the roll 26. In accordance with this solution according to the invention, the further reduction in the diameter of the roll 26 is compensated for by means of the further pivoting of the lever 28. The reduction in the diameter of the roll 26 is schematically indicated in FIG. 12 by the arrow a, while the pivoting movement of the lever 28 is schematically indicated by the arrow e. Following the reconditioning operations performed, the roll 26 is still symmetrical with respect to the axis of rotation r and has become asymmetrical again with respect to the groove plane π. As can be seen in FIG. 10, the radial direction along which the force F is applied forms an angle γ with the groove plane π. Moreover, the groove plane π divides the pertaining nominal arc h, i.e. that on which the roll 26 acts, into two unequal parts. In particular, the angle γ according to FIG. 12 has an opposite sign with respect to the angle γ according to FIG. 10.

The invention also relates to a rolling station 22 comprising a stand 24 and a plurality of rolls 26. Each of said rolls 26 is mounted on the cartridge 25 by means of a lever 28. The lever 28 is in turn mounted on the cartridge 25 so as to be able to pivot about a pin 30. Each roll 26 comprises an actuator 36 suitable for applying to the roll 26 a force able to produce the plastic deformation of the tube 18 being processed. Each roll 26 comprises motor means 38 suitable for causing the rotation of the roll 26 so as to displace the tube 18 by means of friction. In particular, in the station 22, the rolls 26 are of the type described previously with reference to the invention. FIGS. 13 to 15 show a stand 24 according to the invention during its working life affected by the reduction in diameter following reconditioning of the rolls 24 by means of turning. FIG. 13 shows a rolling stand 24 according to the invention at the start of the working life of its rolls 26. In other words, the stand 24 according to FIG. 13 comprises three rolls 26 such as that shown in FIG. 10. FIG. 14 shows the stand 24 of FIG. 13 halfway through the working life of its rolls 26. In other words, the stand 24 according to FIG. 14 comprises three rolls 26 such as that shown in FIG. 11. Finally, FIG. 15 shows the stand 24 of FIGS. 13 and 14 at the end of the working life of its rolls 26. In other words, the stand 24 according to FIG. 15 comprises three rolls 26 such as that shown in FIG. 12.

The invention also relates to a continuous rolling mill 20 for performing the rolling of long semifinished articles, typically seamless tubes 18. The rolling mill 20 according to the invention comprises a plurality of rolling stations 22 and associated stands 24 in accordance with that described above.

The invention relates finally to a method for reconditioning a roll 26 according to the invention when it is worn. The method comprises, in a manner known per se, the step of performing a turning operation on the groove 44 in order to eliminate the deformation and wear marks and restore the profile of the groove 44. This operation results in a reduction in the diameter of the roll 26. In the method according to the invention, moreover, by means of the turning operation it is possible to redefine the nominal arc h so that the bisecting line d rotates with respect to the groove plane π and, at the same time, so that the groove plane π is displaced along the axis r.

In particular, in the method according to the invention, the turning operation carried out on the groove 44 produces, during the first half of the working life of the roll 26, a rotation of the line d bisecting the nominal arc h, towards the groove plane π. Conversely, during the second half of the working life of the roll 26, it produces a rotation of the line d bisecting the nominal arc h, away from the groove plane π.

The main geometrical features assumed by a roll 26 according to the invention during its working life are summarized in schematic form in FIGS. 17 and 18. As can be noted, in FIG. 17, the roll 26 is symmetrical with respect to the axis r, but is asymmetrical with respect to the groove plane π. Moreover, the line d bisecting the pertaining nominal arc h forms an angle γ with the groove plane π. Moreover, the groove plane π divides the roll into two parts having a thickness s′ and s″, respectively, where s′ is smaller than s″. Finally, the crest 44′ has a smaller radius than the crest 44″.

FIG. 17 also shows successive profiles of the groove 44 which are obtained during subsequent reconditioning by means of the method according to the invention. As can be noted in FIG. 17, each turning operation for reconditioning the roll 26 is performed so that the new groove 44 defines a new bisecting line d which is rotated with respect to the previous one. In particular, with specific reference to the view shown in FIG. 17, the bisecting line d rotates gradually in an anti-clockwise direction. In other words, at the start of the working life of the roll 26, the bisecting line d rotates with each reconditioning operation towards the groove plane π, gradually reducing the amplitude of the angle γ. Halfway through the working life of the roll 26 the bisecting line d lies momentarily in the groove plane π, as shown in FIGS. 11 and 14 (where the angle γ is zero). As the end of the working life of the roll 26 nears, the bisecting line d rotates with each reconditioning operation further away from the groove plane π in the direction opposite to that from which it is started, increasing gradually the amplitude of the angle γ which has a sign opposite to the initial sign. FIG. 18 therefore shows the roll 26 at the end of its working life. As can be seen in FIG. 18, the roll 26 is symmetrical with respect to the axis r, but asymmetrical with respect to the groove plane π. Moreover, the line d bisecting the pertaining nominal arc h forms an angle γ with the groove plane π, where the angle γ has an opposite sign to the initial configuration shown in FIG. 17. Moreover, the groove plane π divides the roll into two parts having a thickness s′ and s″, respectively, where s′ is now smaller than s″. Finally, the crest 44′ now has a greater radius than the crest 44″.

As can be seen from the accompanying figures, the thrust surface 46 is curved. In particular, the thrust surface 46 defines a cylindrical segment having an axis t so as to provide the roll with a force F aligned in each case with the bisecting line d (see in particular FIGS. 10 to 12). Moreover, the segment defined by the thrust surface 46 is sufficiently broad to ensure always optimum contact with the actuator 36, both when the roll is new (the angle γ is at its maximum) and when the roll is completely worn (the angle γ is at its minimum).

It should be noted how the angle through which the bisecting line d rotates with each reconditioning operation is equal to the angle through which the lever 28 rotates about the pin 30. This angle is defined by the thickness which must be removed in order to obtain a new optimum profile of the groove 44.

It should be noted that the angle γ in FIGS. 9, 17 and 18 is equal to 10°, but it is much bigger than how it is in reality for greater clarity. In the case of a roll 26 according to the invention, the angle γ actually ranges between −4° and +4° and preferably between −2° and +2°.

It should be noted that, in rolling mills of the known type, great attention has always been paid to ensuring absolute symmetry in each roll and identical measurements between adjacent rolls. In this way, in fact, the shearing stresses induced by different rolling speeds on adjacent tube portions are avoided. On the contrary, in the rolling mill according to the invention, the outer surface of the tube 18 is knowingly subjected to such stresses. In fact, the difference in radius between the two crests 44′ and 44″ has the effect that the identical angular speed (common to the entire roll 26) is converted into different tangential speeds of the crests 44′ and 44″. Since the crest 44′ of a roll 26 is situated in the vicinity of the crest 44″ of the adjacent roll, adjacent tube portions are subject to two different rolling speeds. This difference in speed induces a shearing stress which is parallel to the rolling axis t.

The applicant, when developing the rolling mill according to the invention, has noted that these stresses surprisingly do not constitute a significant drawback. In fact, it can be noted how the rolls 26 shown in FIGS. 10 to 16 do not make contact with the tube 18 along the entire pertaining nominal arc h. This configuration is such that the tube portions 18 subject to different rolling speeds are slightly spaced from each other. In this way, the shearing stress which is generated on the tube owing to the difference in diameter between the crest 44′ of a roll and the crest 44″ of the adjacent roll is of a smaller order of magnitude than the shearing stress which is generated, in the rolling mills of the known type, owing to the difference in diameter between the crests and the groove bottom of the individual roll. This stress is known per se and considered to be entirely acceptable. Moreover, it is substantially compensated for by arranging the following stations 22 angularly out-of-phase about the axis t. In fact, by arranging the stations 22 angularly out-of-phase, it is possible to achieve the result that the tube zone 18, previously rolled by the crests of two adjacent rolls, is subsequently rolled by the groove bottom of an individual roll. In the same way, in the rolling mill 20 according to the invention, the following stations 22 are angularly out-of-phase about the axis t and therefore compensate for the shearing stress introduced by the difference in diameter between the crest 44′ and the crest 44″ of the adjacent roll.

With regard to the embodiments of the continuous rolling mill 20 described above, the person skilled in the art may, in order to satisfy specific requirements, make modifications to and/or replace elements described with equivalent elements, without thereby departing from the scope of the accompanying claims.

1. A rolling station comprising a stand which comprises a plurality of rolls mounted on a cartridge, wherein each of said rolls:
is rotatable about an axis of rotation;
comprises a groove able to reproduce a nominal arc of the outer profile of the semifinished article;
comprises a groove plane which intersects, perpendicularly with respect to the axis of rotation, the roll along its smaller section;
is asymmetrical with respect to the groove plane;
is mounted on the cartridge by means of a lever, the lever being mounted on the cartridge so as to be able to pivot about a pin parallel to the rolling axis;
comprises an actuator suitable for acting on a thrust surface integral with the lever so as to apply to the roll a force F able to cause plastic deformation of the semifinished article being processed; and
wherein the thrust surface is curved and defines a cylindrical segment having axis t, so as to provide the roll with a force F aligned in each case with the bisecting line d.

2. Continuous rolling mill for rolling long semifinished articles, comprising a plurality of rolling stations in accordance with claim 1.

3. A method for reconditioning a roll for rolling a long semifinished article when this roll is worn, said roll being of the type rotatable about an axis of rotation and comprising:
a groove able to reproduce a nominal arc of the outer profile of the semifinished article;
a groove plane which intersects, perpendicularly with respect to the axis of rotation, the roll along its smaller section;
wherein the roll is asymmetrical with respect to the groove plane,
the method comprising the step of carrying out a turning operation on the groove so as to:
eliminate the deformation and wear marks of the groove;
restore the profile of the groove;
reduce the diameter of the roll;
and moreover:
redefine the nominal arc so that the bisecting line rotates with respect to the groove plane;
displace the groove plane along the axis of rotation.

4. The method of claim 3, wherein the roll is of the type in which the line bisecting the nominal arc forms an angle with the groove plane and wherein the step of carrying out a turning operation on the groove produces a rotation of the line bisecting the nominal arc, towards the groove plane, during the first half of the working life of the roll and produces a rotation of the line bisecting the nominal arc, away from the groove plane, during the second half of the working life of the roll.

5. The method of claim 4, wherein the step of carrying out a turning operation on the groove produces a gradual reduction in the amplitude of the angle during the first half of the working life of the roll and causes a gradual increase in the amplitude of the angle, which has a sign opposite to the initial sign, during the second half of the working life of the roll.

6. The method of claim 5, wherein the angle γ ranges between −4° and +4°, and preferably between −2° and +2°, during the entire working life of the roll.

7. The method of claim 6, wherein the roll is of the type in which the groove defines a first crest and a second crest having different radii and wherein at the start of the working life of the roll the first crest has a radius smaller than that of the second crest, while at the end of the working life of the roll the first crest has a radius greater than that of the second crest.

8. The method of claim 7, wherein the roll is of the type in which the groove plane divides the roll into a first part having a first thickness and into a second part having a second thickness and wherein at the start of the working life of the roll the first thickness is smaller than the second thickness, while at the end of the working life of the roll the first thickness is greater than the second thickness.

9. A roll for rolling a long semifinished article rotatable about an axis of rotation and comprising:
a groove able to reproduce a nominal arc of the outer profile of the semifinished article;
a groove plane which intersects, perpendicularly with respect to the axis of rotation, the roll along its smaller section;
wherein the roll is asymmetrical with respect to the groove plane,

10. The roll according to claim 9, wherein the line bisecting the nominal arc forms an angle with the groove plane.

11. The roll according to claim 10, wherein the angle ranges between −4° and +4, and preferably between −2° and +2°.

12. Roll according to claim 11, wherein the groove defines two crests having different radii.

13. Roll according to claim 12, wherein the groove plane divides the roll into two parts having different thicknesses.

14. A rolling station comprising a stand which comprises a plurality of rolls mounted on a cartridge, wherein each of said rolls:
is mounted on the cartridge by means of a lever, the lever being mounted on the cartridge so as to be able to pivot about a pin;
comprises an actuator able to apply to the roll a force able to produce the plastic deformation of the semifinished article being processed.
comprises motor means suitable for causing the rotation of the roll so as to displace the semifinished article by means of friction; and
wherein said rolls are in accordance with claim 9.

15. A continuous rolling mill for rolling long semifinished articles, comprising a plurality of rolling stations in accordance with claim 14.

16. The method of claim 3, wherein the roll is of the type in which the groove defines a first crest and a second crest having different radii and wherein at the start of the working life of the roll the first crest has a radius smaller than that of the second crest, while at the end of the working life of the roll the first crest has a radius greater than that of the second crest.

17. The method of claim 4, wherein the roll is of the type in which the groove defines a first crest and a second crest having different radii and wherein at the start of the working life of the roll the first crest has a radius smaller than that of the second crest, while at the end of the working life of the roll the first crest has a radius greater than that of the second crest.

18. The method of claim 5, wherein the roll is of the type in which the groove defines a first crest and a second crest having different radii and wherein at the start of the working life of the roll the first crest has a radius smaller than that of the second crest, while at the end of the working life of the roll the first crest has a radius greater than that of the second crest.

19. The method of claim 3, wherein the roll is of the type in which the groove plane divides the roll into a first part having a first thickness and into a second part having a second thickness and wherein at the start of the working life of the roll the first thickness is smaller than the second thickness, while at the end of the working life of the roll the first thickness is greater than the second thickness.

20. The method of claim 4, wherein the roll is of the type in which the groove plane divides the roll into a first part having a first thickness and into a second part having a second thickness and wherein at the start of the working life of the roll the first thickness is smaller than the second thickness, while at the end of the working life of the roll the first thickness is greater than the second thickness.

21. The method of claim 5, wherein the roll is of the type in which the groove plane divides the roll into a first part having a first thickness and into a second part having a second thickness and wherein at the start of the working life of the roll the first thickness is smaller than the second thickness, while at the end of the working life of the roll the first thickness is greater than the second thickness.

22. The method of claim 6, wherein the roll is of the type in which the groove plane divides the roll into a first part having a first thickness and into a second part having a second thickness and wherein at the start of the working life of the roll the first thickness is smaller than the second thickness, while at the end of the working life of the roll the first thickness is greater than the second thickness.

23. The roll of claim 9, wherein the groove defines two crests having different radii.

24. The roll of claim 10, wherein the groove defines two crests having different radii.

25. The roll of claim 9, wherein the groove plane divides the roll into two parts having different thicknesses.

26. The roll of claim 10, wherein the groove plane divides the roll into two parts having different thicknesses.

27. The roll of claim 11, wherein the groove plane divides the roll into two parts having different thicknesses.

28. A rolling station comprising a stand which comprises a plurality of rolls mounted on a cartridge, wherein each of said rolls:
is mounted on the cartridge by means of a lever, the lever being mounted on the cartridge so as to be able to pivot about a pin;
comprises an actuator able to apply to the roll a force able to produce the plastic deformation of the semifinished article being processed;
comprises motor means suitable for causing the rotation of the roll so as to displace the semifinished article by means of friction; and
wherein said rolls are in accordance with claim 10.

29. A continuous rolling mill for rolling long semifinished articles, comprising a plurality of rolling stations in accordance with claim 28.

30. A rolling station comprising a stand which comprises a plurality of rolls mounted on a cartridge, wherein each of said rolls:
is mounted on the cartridge by means of a lever, the lever being mounted on the cartridge so as to be able to pivot about a pin;
comprises an actuator able to apply to the roll a force able to produce the plastic deformation of the semifinished article being processed.
comprises motor means suitable for causing the rotation of the roll so as to displace the semifinished article by means of friction; and
wherein said rolls are in accordance with claim 11.

31. A continuous rolling mill for rolling long semifinished articles, comprising a plurality of rolling stations in accordance with claim 30.

32. A rolling station comprising a stand which comprises a plurality of rolls mounted on a cartridge, wherein each of said rolls:
is mounted on the cartridge by means of a lever, the lever being mounted on the cartridge so as to be able to pivot about a pin;
comprises an actuator able to apply to the roll a force able to produce the plastic deformation of the semifinished article being processed.
comprises motor means suitable for causing the rotation of the roll so as to displace the semifinished article by means of friction; and
wherein said rolls are in accordance with claim 12.

33. A continuous rolling mill for rolling long semifinished articles, comprising a plurality of rolling stations in accordance with claim 32.

34. A rolling station comprising a stand which comprises a plurality of rolls mounted on a cartridge, wherein each of said rolls:
is mounted on the cartridge by means of a lever, the lever being mounted on the cartridge so as to be able to pivot about a pin;
comprises an actuator able to apply to the roll a force able to produce the plastic deformation of the semifinished article being processed.
comprises motor means suitable for causing the rotation of the roll so as to displace the semifinished article by means of friction; and
wherein said rolls are in accordance with claim 13.

35. A continuous rolling mill for rolling long semifinished articles, comprising a plurality of rolling stations in accordance with claim 34.
